(19) United States
(12) Patent Application Publication
(10) Pub. No.: US 2016/0053812 A1
(43) Pub. Date: Feb. 25, 2016

(54) BEARING ASSEMBLY AND METHOD FOR ASSEMBLING AND MOUNTING SAID BEARING ASSEMBLY WITH A COMPONENT SUPPORTING SAID BEARING ASSEMBLY

(71) Applicant: AKTIEBOLAGET SKF, Goteborg (SE)

(72) Inventors: Laurent Varnoux, Saint Avertin (FR); Olivier Verbe, Tours (FR)

(73) Assignee: AKTIEBOLAGET SKF, Göteborg (SE)

(21) Appl. No.: 14/780,958

(22) PCT Filed: Mar. 28, 2013
(86) PCT No.: PCT/EP2013/056741

§ 371 Date: Sep. 28, 2015

(51) Int. Cl. F16C 35/077; F16C 43/04; F16C 19/52; F16C 19/06; F16C 25/06

(52) U.S. Cl. CPC F16C 35/077; F16C 19/06; F16C 25/06; F16C 19/525; F16C 43/04

(57) ABSTRACT

A bearing assembly includes at least one ring arranged between first and second components, the second component being mounted for rotation relative to the first component. The bearing assembly includes a first layer of expandable material disposed axially between a first radial lateral surface of the at least one ring and one of the first and second components, and the first layer of expandable material has been irreversibly expanded by a heat treatment at a temperature above a first temperature threshold.

The present invention relates to bearings, in particular bearings having at least one ring. The bearings may be, for example, rolling bearings, bushing bearings or plain bearings used in industrial electric motors.

In particular, the present invention relates to rolling bearings having an inner ring and an outer ring with one or more rows of rolling elements held by a cage between raceways provided in the two rings. The rolling elements may, for example, be balls.

An electric motor generally comprises a casing inside which is mounted a stator and a rotor mounted for rotation relatively to the stator. Two bearings are supported by said stator and rotor, located at each end of the rotor's shaft.

In such applications, known ISO deep groove ball bearings are usually used. These bearings comprise inner and outer rings of the massive or solid type. A “solid ring” is to be understood as a ring obtained by machining with removal of material (by turning, grinding) from steel tube stock, bar stock, rough forgings and/or rolled blanks. Such rolling bearings are mainly loaded radially and have their inner rings mounted with a tight fit on the shaft of the rotor. The outer rings of the bearings are mounted in cylindrical housings of the motor's casing. Said casing is generally made in light alloy aluminium.

The expansion coefficient of the casing of the motor is higher than the expansion coefficient of the rings of the bearings. In case of a temperature increase, a clearance between the outer rings of the bearings and the cylindrical bore of the casing is created, which leads to a rotation of the outer rings of the bearings.

In order to avoid such rotation of the outer ring of the bearing, FR 2 835 580 discloses a rolling bearing comprising an inner ring and an outer ring with at least one row of rolling elements, and a expansion compensation ring mounted in a annular groove provided on the outer cylindrical surface of the outer ring of the rolling bearing.

However, during low temperature, such as 0° C., the expansion compensation ring is not in contact with the housing of the casing, the outer ring of the rolling bearing is thus not reliably fixed to the housing and may rotate compared to the housing.

It is a particular object of the present invention to provide a rolling bearing assembly having an axial preload and a ring permanently and reliably fixed to the housing and/or the shaft of the motor.

It is another object of the present invention to allow easy dissembling of the rolling bearing assembly out of the motor.

Finally, it is an object of the present invention to provide a rolling bearing assembly having damping properties.

In one embodiment, a bearing assembly comprises a bearing assembly comprising at least one ring arranged between two components supporting said bearing assembly, one component being mounted for rotation relatively to the other component.

The bearing assembly comprises at least one layer of expandable material disposed axially between at least one radial lateral surface of said one ring and one of said components, said layer of expandable material having been expanded by a heat treatment until a temperature threshold of deformation in a non-reversible way.

The layer of expendable material is thus deformed plastically in a non-reversible way and thus permanently deformed, so as to stay expanded, even under temperature variation. Said ring is thus axially assembled with the component to be assembled with.

In another embodiment, a second layer of expandable material disposed axially between a second radial lateral surface of one of said rings, opposite to said one radial lateral surface of said one ring, and one of said components.

The bearing assembly may, for example, comprise rolling elements located between said one ring and the other component.

In an embodiment, the bearing assembly comprises an inner ring, an outer ring and rolling elements being disposed between raceways provided on said inner and outer rings.

The first layer of expandable material is, for example, disposed axially between a first radial lateral surface of said outer ring and the component supporting said outer ring. The layer of expendable material being deformed plastically in a non-reversible way and thus permanently deformed, so as to stay expanded, even under temperature variation, said outer ring is thus axially assembled with the casing.

For example, said another layer of expandable material is disposed axially between a second radial lateral surface of said outer ring, opposite to the first radial lateral surface of said outer ring, and the component supporting said outer ring.

In another embodiment, another layer of expandable material is disposed axially between a radial lateral surface of said other ring and one of said components, said radial lateral surface of said other ring being opposite to said radial lateral surface of said one ring. The rolling bearing assembly is thus axially preloaded in an easy way and does not require the use of axial washers or screw nuts.

For example, said another layer of expandable material is disposed axially between a radial lateral surface of said inner ring, opposite to the first radial lateral surface of said outer ring, and the component supporting said inner ring.

Advantageously, said one ring comprises on one of its radial lateral surface, at least one annular groove and in that a layer of expandable material is disposed in said groove.

The layer of expandable material may comprise a shell and a fluid encapsulated inside said shell, said fluid having its internal pressure increased when the temperature reaches a first temperature threshold, said shell being deformed in a non-reversible way when the temperature reaches a second temperature threshold and rupture when the temperature reaches a third temperature threshold.

For example, the first temperature threshold is comprised between 80° C. and 95° C., for example of 90° C., the second temperature threshold is comprised between 120° C. and 135° C., for example of 130° C., and the third temperature threshold is higher than 140° C., for example 200° C.

According to a second aspect, it is proposed an electric motor comprising a casing, a rotor mounted in rotation in said casing and at least one bearing assembly as described above arranged between the casing and the rotor. According to another aspect, it is proposed a method of assembling a bearing assembly comprising at least one ring arranged between two components supporting said bearing assembly, one component being mounted for rotation relatively to the other component, comprising the steps of positioning axially a layer of expandable material between at least one ring of said bearing assembly and the component to be assembled with and heating the layer of expandable material until a temperature threshold of deformation in a non-reversible way.

The present invention will be better understood from studying the detailed description of a number of embodiments considered by way of entirely non-limiting examples and illustrated by the attached drawings in which:

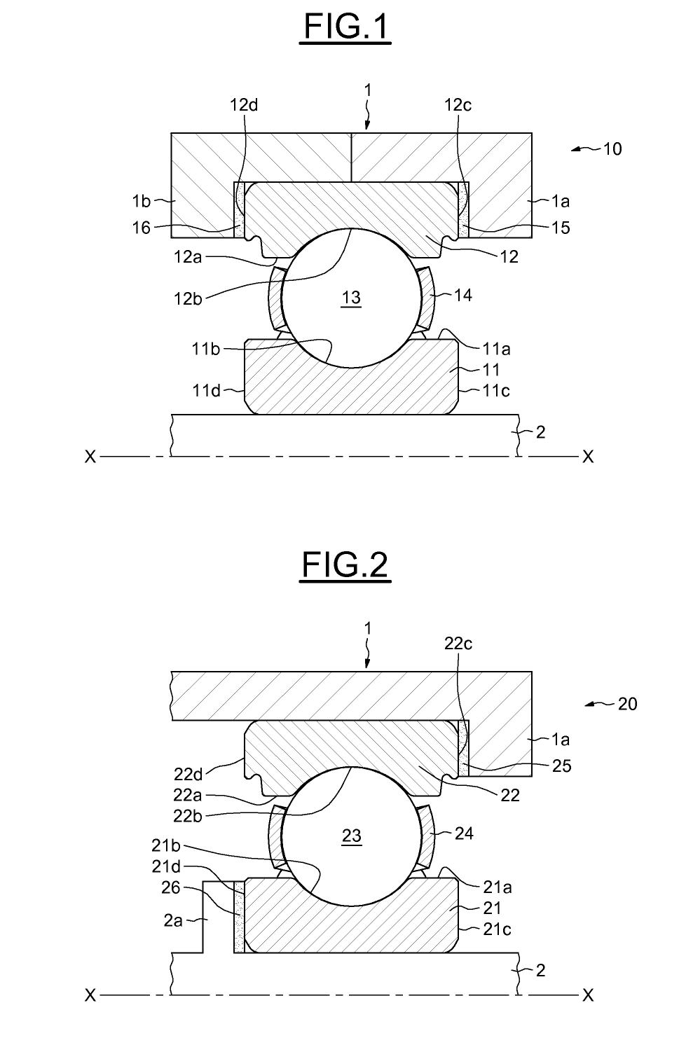

FIG. 1 is an axial half-section of the rolling bearing assembly according to a first embodiment of the invention mounted between two components of a motor; and

FIG. 2 is an axial half-section of the rolling bearing assembly according to a second embodiment of the invention.

As illustrated on FIG. 1, a rolling bearing assembly, having a rotational axis X-X and designed by general reference number 10, comprises an inner ring 11, an outer ring 12, a row of rolling elements 13 consisting, in the example illustrated, of balls, held by a cage 14 between the inner ring 11 and the outer ring 12.

The rolling bearing assembly 10 is designed to be mounted in an electric motor (not shown) having a casing inside which is mounted a stator and a rotor mounted for rotation relatively to the stator. As illustrated on the figures, the rolling bearing assembly 10 is designed to be supported by two mechanical components, such as for example the casing 1 of the electric motor and the shaft 2 of the rotor. The inner ring 11 is solid and has on its outer cylindrical surface 11a a toroidal groove 11b, the radius of curvature of which is slightly greater than the radius of the rolling elements 13 and forms a bearing race for the rolling elements 13. The inner ring 11 may be manufactured by machining or by pressing a steel blank, which is then ground and optionally lapped at the bearing race 11b in order to give the ring 11 its geometrical characteristics and its final surface finish. The inner ring 11 is delimited by two radial lateral surfaces 11c, 11d.

The outer ring 12 is solid and has on its inner cylindrical surface 12a a toroidal groove 12b, the radius of curvature of which is slightly greater than the radius of the rolling elements 13 and forms a bearing race for the rolling elements 13. The outer ring 12 may be manufactured by machining or by pressing a steel blank, which is then ground and optionally lapped at the bearing race 12b in order to give the ring 12 its geometrical characteristics and its final surface finish. The outer ring 12 is delimited by two radial lateral surfaces 12c, 12d.

Alternatively, the outer and/or inner ring may comprise two half ring parts or half rings identical and symmetric with respect to the axial plane of symmetry of the bearing 10.

As illustrated, the rolling bearing assembly 10 comprises a first annular layer 15 of expandable material located axially between a first radial lateral surface 12c of the outer ring 12 and a first shoulder 1a of the casing 1. The layer 15 of expandable material is disposed so as to cover substantially the entire lateral surface 12c of said outer ring 12.

As shown on FIG. 1, a second annular layer 16 of expandable material is located axially between a second radial lateral surface 12d of the outer ring 12 and a second shoulder lb of the casing 1. The second layer 16 of expandable material is disposed so as to cover substantially the entire lateral surface 12d of said outer ring 12. As illustrated the casing 1 is a two-piece casing. However, it is noted that the casing 1 can be a one piece casing comprising a retaining ring axially retaining said second layer 16 of expandable material. As an alternative, the layers 15, 16 could cover only a part of the radial lateral surfaces 12c, 12d of the outer ring 12. The outer ring 12 is thus permanently axially assembled to the casing 1.

As an alternative, the rolling bearing assembly 10 may comprise only one layer 15 of expandable material.

Both layers 15, 16 are made of a material having the properties to expand when the temperature inside the bearing assembly 10 reaches a first temperature threshold T₁, such as for example between 80° C. and 95° C., for example of 90° C.

Each layers 15, 16 comprise a shell and a fluid, such as for example gas, encapsulated inside said shell. For example, the fluid particles can have a diameter comprised between 10 μm and 16 μm and have a density comprised between 5 kg/m³ and 15 kg/m³. Said fluid has its internal pressure increased when the temperature T reaches the first temperature threshold T₁ and expand the shell with the increase of temperature. The shell is deformed plastically in a non-reversible way when the temperature T reaches a second temperature threshold T₂ and rupture when the temperature T reaches a third temperature threshold T₃. The second temperature threshold T₂ is for example comprised between 120° C. and 135° C., for example of 130° C., and the third temperature threshold T₃ is, for example, higher than 200° C.

Alternatively, each or one of the radial lateral surfaces 12c, 12d may be provided with one or two grooves for receiving the layers 15, 16 of expandable material in the shape of a toroidal ring.

Alternatively, the layers 15, 16 of expandable material could be located between the radial lateral surfaces 11c, 11d of the inner ring 11 and a shoulder (not shown) of the shaft's rotor 2.

As an alternative, the rotor's shaft 2 may comprise shoulder or a retaining ring for axially retaining the inner ring 11. In such case, the rolling bearing assembly 10 is axially preloaded.

The bearing assembly 10 is assembled with the casing 1 or the shaft 2 as follows.

A first layer 15 of expandable material is axially positioned between the a first radial lateral surface 12c of the outer ring 12 and a first shoulder la of the casing 1, so as to cover substantially the entire lateral surface 12c of said outer ring 12. A second layer 16 of expandable material is axially positioned between the a second radial lateral surface 12d of the outer ring 12 and a second shoulder 1b of the casing 1, so as to cover substantially the entire lateral surface 12d of said outer ring 12.

The bearing assembly 10 is then heated until the second temperature threshold T₂, so as to deform plastically the shell of the layers 15, 16 of expandable material. The shell is thus permanently deformed and stay expanded, even when temperature decreases.

In order to disassemble the outer ring 12 of the rolling bearing 10 and the casing 1, temperature is increased to the third temperature threshold T₃. When the temperature reaches the third temperature threshold T₃, the shell of the layers 15, 16 explodes and the outer ring 12 of the bearing assembly is disassembled with the casing 1.

In the embodiment of FIG. 2 in which identical elements bear the same references, differs from the embodiment of FIG. 1 on the location of the layers of expandable material.

As illustrated on FIG. 2, a rolling bearing assembly, having a rotational axis X-X and designed by general reference number 20, comprises an inner ring 21, an outer ring 22, a row of rolling elements 23 consisting, in the example illustrated, of balls, held by a cage 24 between the inner ring 21 and the outer ring 22.

The rolling bearing assembly 20 is designed to be mounted in an electric motor (not shown) having a casing inside which is mounted a stator and a rotor mounted for rotation relatively to the stator. As illustrated on the figures, the rolling bearing assembly 20 is designed to be supported by two mechanical components, such as for example the casing 1 of the electric motor and the shaft 2 of the rotor.

The inner ring 21 is solid and has on its outer cylindrical surface 21a a toroidal groove 21b, the radius of curvature of which is slightly greater than the radius of the rolling elements 23 and forms a bearing race for the rolling elements 23. The inner ring 21 may be manufactured by machining or by pressing a steel blank, which is then ground and optionally lapped at the bearing race 21b in order to give the ring 21 its geometrical characteristics and its final surface finish. The inner ring 21 is delimited by two radial lateral surfaces 21c, 21d.

The outer ring 22 is solid and has on its inner cylindrical surface 22a a toroidal groove 22b, the radius of curvature of which is slightly greater than the radius of the rolling elements 23 and forms a bearing race for the rolling elements 23. The outer ring 22 may be manufactured by machining or by pressing a steel blank, which is then ground and optionally lapped at the bearing race 22b in order to give the ring 22 its geometrical characteristics and its final surface finish. The outer ring 22 is delimited by two radial lateral surfaces 22c, 22d.

Alternatively, the outer and/or inner ring may comprise two half ring parts or half rings identical and symmetric with respect to the axial plane of symmetry of the bearing 20.

As illustrated, the rolling bearing assembly 20 comprises a first annular layer 25 of expandable material located axially between a first radial lateral surface 22c of the outer ring 22 and a first shoulder 1a of the casing 1. The layer 25 of expandable material is disposed so as to cover substantially the entire lateral surface 22c of said outer ring 22.

As shown on FIG. 1, a second annular layer 26 of expandable material is located axially between the second radial lateral surface 21d of the inner ring 21 and a second shoulder 2a of the rotor's shaft 2, opposite to the first radial lateral surface 22c of the outer ring 22. The second layer 26 of expandable material is disposed so as to cover substantially the entire lateral surface 21d of said inner ring 21. As illustrated the casing 1 is a two-piece casing. As an alternative, the layers 25, 26 could cover only a part of the radial lateral surfaces 22c, 21d of the outer and inner rings 21, 22.

As an alternative, the first layer of expandable material may be located between the second radial lateral surface 22d of the outer ring 22 and a second shoulder (not shown) of the casing 1 and the second layer of expandable material may be located between the first radial lateral surface 21c of the inner ring 21, opposite to the second radial lateral surface 22d of the outer ring 22.

The rolling bearing assembly 20 is thus axially assembled with an axial preload.

As an alternative, the rolling bearing assembly 20 may comprise only one layer of expandable material located on a first radial lateral surface of one of the rings 21, 22, the radial lateral surface of the other ring, opposite to the first radial lateral surface compared to the plane of symmetry passing through the rolling elements 23 being axially retained by a shoulder or a retaining ring on the rotor's shaft or the casing.

The layers 25, 26 have the same thermal properties and characteristics as the layers 15, 16 of FIG. 1.

Both layers 25, 26 are made of a material having the properties to expand when the temperature inside the bearing assembly 20 reaches a first temperature threshold T₁, such as for example between 80° C. and 95° C., for example of 90° C.

Each layers 25, 26 comprise a shell and a fluid, such as for example gas, encapsulated inside said shell. For example, the fluid particles can have a diameter comprised between 10 μm and 16 μm and have a density comprised between 5 kg/m³ and 15 kg/m³. Said fluid has its internal pressure increased when the temperature T reaches the first temperature threshold T₁ and expand the shell with the increase of temperature. The shell is deformed plastically in a non-reversible way when the temperature T reaches a second temperature threshold T₂ and rupture when the temperature T reaches a third temperature threshold T₃. The second temperature threshold T₂ is for example comprised between 120° C. and 135° C., for example of 130° C., and the third temperature threshold T₃ is, for example, higher than 200° C.

As an alternative, each or both layers 25, 26 may have the shape of a toroidal ring and be located in one or two grooves provided on the lateral surfaces of the inner and/or outer rings 21, 22.

The bearing assembly 20 is assembled with the casing 1 or the shaft 2 as follows.

A first layer 25 of expandable material is axially positioned between the a first radial lateral surface 22c of the outer ring 22 and a first shoulder 1a of the casing 1, so as to cover substantially the entire lateral surface 22c of said outer ring 22. A second layer 26 of expandable material is axially positioned between the a second radial lateral surface 21d of the inner ring 21 and a shoulder 2a of the rotor's shaft 2, so as to cover substantially the entire lateral surface 21d of said inner ring 21.

The bearing assembly 20 is then heated until the second temperature threshold T₂, so as to deform plastically the shell of the layers 25, 26 of expandable material. The shell is thus permanently deformed and stay expanded, even when temperature decreases.

Although the invention has been illustrated on the basis of a rolling bearing, it should be understood that the invention can be applied to plain bearings or bushing bearings.

The layers of expandable material shown in FIGS. 1 and 2 can have the shape of an annular ring or can be a portion of an annular ring or a plurality of portions of an annular ring radially spaced.

Thanks to the invention and to the thermal properties of the layer of expandable material, at least one ring of the bearing assembly is permanently assembled with the casing or the shaft of the motor. The rings bearing assembly are not subjected to rotate relatively to the component to be assembled with. Moreover, the bearing assembly is easily dissembled from the components supporting the bearing assembly by heat treatment until a temperature threshold allowing the layer of expandable material to rupture. The volume of the expanded layer is thus decreased.

Furthermore, the layer of expandable material has damping properties such that noise and vibrations of the shaft are damped.

Such rolling bearing allows an axial preloaded when a layer of expandable material is axially disposed on opposite radial lateral surface of each rings.

1. A bearing assembly comprising at least one ring arranged between first and second components the second component being mounted for rotation relative to the first component wherein the bearing assembly comprises a first layer of expandable material disposed axially between a first radial lateral surface of said at least one ring and one of said first and second components, said first layer of expandable material having been irreversibly expanded by a heat treatment at a temperature above a first temperature threshold.

2. The bearing assembly according to claim 1, comprising a second layer of expandable material disposed axially between a second radial lateral surface of said at least one ring, opposite to said first radial lateral surface and one of said first and second components.

3. The bearing assembly according to claim 1, comprising rolling elements located between said at least one ring and the second component.

4. The bearing assembly according to claim 1, wherein said at least one ring comprises an outer ring supported by said first component and an inner ring and including rolling elements between raceways provided on said inner ring and said outer ring.

5. The bearing assembly according to claim 4, wherein the first layer of expandable material is disposed axially between the first radial lateral surface of said outer ring and the first component.

6. The bearing assembly according to claim 5, wherein a second layer of expandable material is disposed axially between a second radial lateral surface of said outer ring, opposite to the first radial lateral surface of said outer ring, and the first component.

7. The bearing assembly according to claim 5, wherein a second layer of expandable material is disposed axially between a radial lateral surface of said inner ring, opposite to the first radial lateral surface of said outer ring, and the second component.

8. The bearing assembly according to claim 1, wherein said at least one ring comprises on one of its radial lateral surfaces, at least one annular groove and wherein the first layer of expandable material is disposed in said at least one annular groove.

9. The bearing assembly according to claim 1, wherein the first layer of expandable material comprises a shell and a fluid encapsulated inside said shell, said fluid being configured to expand in response to temperature increases and said shell being configured to deform in a non-reversible way when a temperature reaches the first temperature threshold and rupture when the temperature reaches a second temperature threshold.

10. The bearing assembly according to claim 9, wherein is between 120° C. and 135° C., and the third second temperature threshold is higher than 200° C.

11. An electric motor comprising a casing, a rotor mounted for rotation in said casing and at least one bearing assembly according to claim 1 arranged between the casing and the rotor.

12. A method of assembling a bearing assembly comprising at least one ring arranged between first and second components, the second component being mounted for rotation relative to the first component, the method comprising positioning axially a first layer of expandable material between said at least one ring and the first component and heating the first layer of expandable material until a temperature threshold is reached at which the first layer of material deforms in a non-reversible way.

13. The method according to claim 12, wherein the first layer of expandable material comprises a shell and including a fluid in the shell, the method including heating the fluid to expand the fluid and stretch the shell before the temperature threshold is reached.

14. The method according to claim 12, including heating the layer of expandable material until the shell ruptures.

15. A bearing assembly comprising:
a first component;
a second component mounted for rotation relative to the first component;
a bearing outer ring mounted to the first component;
a bearing inner ring mounted to the second component; and
a first layer of expandable material between the a first lateral radial wall of the bearing outer ring and the first component, the first layer of expandable material being reversibly deformable at temperatures below a temperature threshold and ceasing to be reversibly deformable after the temperature threshold has been exceeded.

16. The bearing assembly according to claim 15, wherein the first layer of expandable material has been raised to a temperature above the temperature threshold and has ceased to be reversibly deformable.

17. The bearing assembly according to claim 16 wherein the first layer of expandable material comprises a shell and including a fluid in the shell.

18. The bearing assembly according to claim 15 including a second layer of expandable material located between a second lateral radial wall of the bearing outer ring and the first component, the second lateral radial wall of the bearing outer ring being axially spaced from the first lateral radial wall of the bearing outer ring.

19. The bearing assembly according to claim 15 including a second layer of expandable material located between a first lateral radial wall of the bearing inner ring and the second component, the first lateral radial wall of the bearing inner ring being axially spaced from the first lateral radial wall of the bearing outer ring.
